(19) United States
(12) Patent Application Publication
(10) Pub. No.: US 2002/0122098 A1
(43) Pub. Date: Sep. 5, 2002

(54) Inkjet recording head adapted for improved precision of mounting

(76) Inventor: Takuro Sekiya, Yokohama-shi (JP)

Correspondence Address: RICHARD F. JAWORSKI, Cooper & Dunham LLP, 1185 Avenue of the Americas, New York, NY, 10036, US

(21) Appl. No.: 10/135,000

(22) Filed: Apr. 29, 2002

Related U.S. Application Data
(62) Division of application No. 08/547,904, filed on Oct. 25, 1995.
Application No. 08/547,904 is a continuation of application No. 08/162,650, filed on Dec. 6, 1993, now abandoned.

(30) Foreign Application Priority Data
Dec. 9, 1992 (JP) 4-329078

(51) Int. Cl. B41J 2/14

(52) U.S. Cl. 347/50

(57) ABSTRACT

A recording head of an inkjet printer includes a recording head unit carrying thereon a head chip for ejecting an inkjet and an ink reservoir for storing the ink. The ink reservoir is mounted upon the recording head unit and detachably held thereto by an interconnection mechanism that includes a rigid tubular member with stainless steel mesh filter provided on the recording head unit for insertion into the ink reservoir.

### BACKGROUND OF THE INVENTION

The present invention generally relates to inkjet printers and more particularly to a recording head of such an inkjet printer.

Inkjet printers are used extensively for printers of personal computers and other information processing apparatuses.

Conventional inkjet printers have a recording head for ejecting ink toward a recording object in the form of inkjet and an ink reservoir for holding the ink, wherein the ink reservoir is formed separate from the. recording head and the ink is supplied to the recording head from the reservoir via an interconnection tube. Such a construction of the inkjet printer is disclosed for example in the Japanese Laid-open Patent Publication 57-24283. On the other hand, such a construction of the conventional inkjet recording apparatus to use the interconnection tube is complex and increases the size of the recording apparatus. Further, such a construction requires a substantial workload of the user of the printer when replacing the ink reservoir.

On the other hand, another type of inkjet recording apparatus is disclosed in the Japanese Laid-open Patent Publications 3-101954-3-101972, wherein the recording head is fixed upon the ink reservoir. Thereby, the recording head and the ink reservoir form an integral cartridge. By constructing the inkjet recording apparatus as such, one can eliminate the interconnection tube between the head and the ink reservoir and the construction of the printer apparatus is substantially simplified. Further, the overall size of the recording apparatus is reduced.

In the latter integral type inkjet recording apparatus, the integral cartridge is replaced by a new one when the ink in the ink reservoir is used up. As the recording head is much more expensive as compared with the ink reservoir, such a construction of the integral cartridge has a drawback of high running cost although the workload of the user to replace the ink reservoir is substantially reduced.

### SUMMARY OF THE INVENTION

Accordingly, it is a general object of the present invention to provide a novel and useful recording head unit of an inkjet recording apparatus wherein the foregoing problems are eliminated.

Another and more specific object of the present invention is to provide a recording head unit of an inkjet recording apparatus, comprising a recording head part for recording an image on a recording object by forming a jet of ink and an ink reservoir part for containing the ink wherein the ink reservoir part alone is replaced when the ink contained therein is used up with a simple working procedure of the user.

Another object of the present invention is to provide a recording head of an inkjet recording apparatus for recording an image on an object, comprising:

a recording head unit supplied with ink for recording an image on a recording object by forming a jet of the ink, said recording head unit comprising: a nozzle for ejecting said jet; a passage of ink provided in communication with said ink nozzle-for supplying said ink to said nozzle; an energization part provided on said passage for applying energy to said ink in said passage to form said jet; and an ink inlet formed in communication with said passage for receiving said ink, said inlet including therein filter means which is made from stainless steel mesh for eliminating particles from said ink supplied to said inlet; and

an ink reservoir unit for holding therein said ink, said ink reservoir supplying said ink held therein to said inlet of said recording head part, said ink reservoir accommodating therein a material infiltrated with said ink;

said recording head unit carrying thereon first connection means as a part of said recording head unit, for connecting said recording head unit to said ink reservoir unit;

said ink reservoir unit carrying thereon second connection means corresponding to said first connection means as a part of said ink reservoir unit, for connecting said ink reservoir unit to said recording head unit;

said first and second connection means being so formed that said first and second connection means establish, when said ink reservoir unit is mounted upon said recording head unit, a detachable engagement with each other in a manner, such that said ink in said reservoir unit flows to said passage in said recording head unit.

According to the present invention, one can eliminate the complex interconnection tube between the ink reservoir and the recording head while allowing continuous use of expensive recording head unit when the ink held in the ink reservoir unit is used up. By holding the ink in the state infiltrated in a medium, one can avoid the formation of bubbles in the ink reservoir unit even when the recording head is shaken violently.

In a preferred embodiment of the present invention, said recording head further includes a carriage member adapted to be mounted upon an image recording apparatus for carrying said recording head unit and said reservoir unit together in the state that said recording head unit and said reservoir unit are connected with each other, said carriage member having a positioning part for determining the position of said nozzle of said recording head unit with respect to said carriage member. By providing the carriage member, one can maintain an exact alignment of the recording head. unit with respect to the recording apparatus and hence to a recording object such as a recording sheet before and after the replacement of the ink reservoir.

In another preferred embodiment of the present invention, said carriage member includes a base part for carrying said recording head unit and said ink reservoir unit and a cover part mounted upon said base part in a manner rotatable with respect thereto, said positioning part being provided on said base part in the form of a cutout adapted to the shape of said recording head unit for holding said recording head unit therein, said cover part urging said recording head unit resiliently upon said base part.

In another preferred embodiment of the present invention, said cover part carries thereon an interconnection pattern for carrying electric signals, said recording head unit thereby establishing an electrical contact with said interconnection pattern when said recording head unit and said ink reservoir unit are mounted upon said carriage member.

In another preferred embodiment of the present invention, said recording head unit has a first guide part for guiding said ink reservoir unit with respect to said recording head unit along a path for mounting and dismounting said ink reservoir unit on and from said recording head unit, said ink reservoir unit having a corresponding second guide part for engagement with said first guide part.

In another preferred embodiment of the present invention, said recording head unit has a generally L-shaped form having a front part and a top part connected with each other, said ink reservoir unit having a rectangular shape having a front surface for engagement with said front part of said recording heat unit and a top surface for engagement with said top part of said recording head unit, said recording head unit carrying said first guide part at a lower surface of said top part while said reservoir part carrying said second guide part at said top surface.

In another preferred embodiment of the present invention, said second connection means of said ink reservoir unit comprises an opening and a seal membrane sealing said opening, said first connection means of said recording head unit being provided so as to break said seal membrane when said ink reservoir unit is mounted upon said recording head unit.

In another preferred embodiment of the present invention, said first connection means of said recording head unit comprises a substantially rigid tubular member for insertion into said ink reservoir part such that said tubular member breaks said seal membrane when said ink reservoir unit is mounted upon said recording head part, said tubular member having a passage of ink therein in communication with said passage of ink in said recording head unit.

In another preferred embodiment of the present invention, said tubular member has a sharp pointed part that breaks said seal membrane when said ink reservoir unit is mounted upon said recording head unit.

In another preferred embodiment of the present invention, said ink reservoir unit further has a vent for communicating an interior and an exterior of said ink reservoir unit, said vent being closed by a removable seal member.

In another preferred embodiment of the present invention, said removable seal member comprises a screw threaded into a wall of said ink reservoir unit.

In another preferred embodiment of the present invention, said removable seal member comprises a substantially rigid projection formed unitrarily to a wall of said ink reservoir unit in correspondence to said vent for closing said vent, said projection being so shaped that said vent is formed upon breaking of said projection.

Other objects and further features of the present invention will become apparent from the following detailed description when read in conjunction with the attached drawings.

### BRIEF DESCRIPTION OF THE DRAWINGS

FIG. 1 is a diagram showing a recording head unit according to a first embodiment of the present invention in a perspective view;

FIG. 2 is a diagram showing the recording head unit of FIG. l in a cross sectional view;

FIG. 3 is a diagram showing the recording head unit of FIG. 1 in an exploded view;

FIG. 4 is a diagram showing a head chip used in the recording head unit of FIG. 1 in a perspective view;

FIG. 5 is a diagram showing the head chip of FIG. 4 in an exploded view;

FIG. 6 is a diagram showing a part of the head chip of FIG. 4 in an enlarged cross sectional view;

FIG. 7 is a diagram showing the connection of an ink reservoir to a recording head part in the recording head unit of FIG. 1;

FIG. 8 is a diagram showing a part of the ink reservoir used in the recording head unit of FIG. 1 in an enlarged cross sectional view;

FIG. 9 is a diagram showing the construction of a carriage used in an inkjet printer for holding the recording head unit of FIG. 1 with a proper positional alignment;

FIG. 10 is a diagram showing the state wherein the recording head unit is held on the carriage of FIG. 9 in a cross sectional view;

FIG. 11 is a diagram showing a second embodiment of the present invention in the state before the ink reservoir is mounted upon the recording head part in an enlarged cross sectional view;

FIG. 12 is a diagram similar to FIG. 11 showing the second embodiment in the state wherein the ink reservoir is mounted upon the recording head part; and

FIGS. 13(A) and 13(B) are diagrams showing a third embodiment of the present invention in a cross sectional view.

### DETAILED DESCRIPTION OF PREFERRED EMBODIMENTS

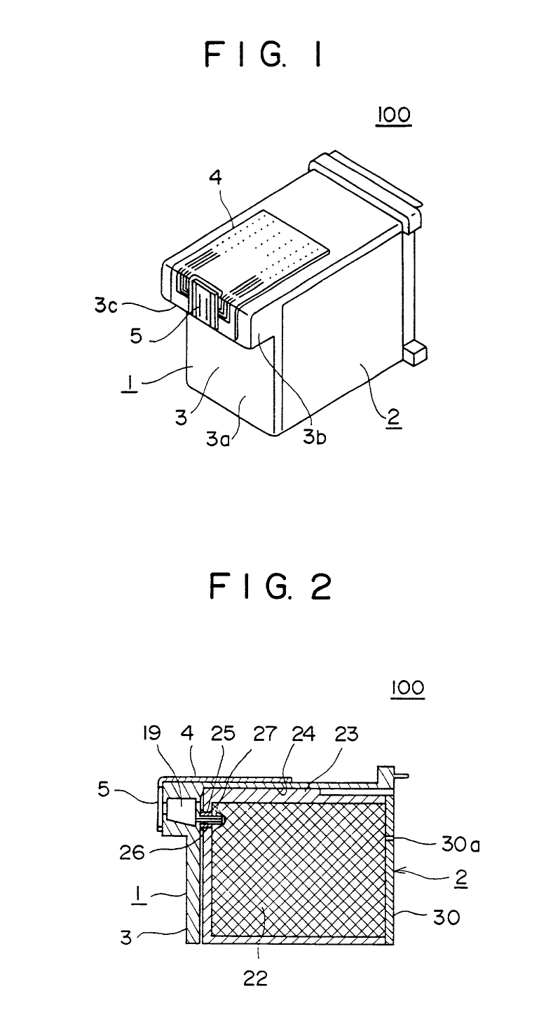

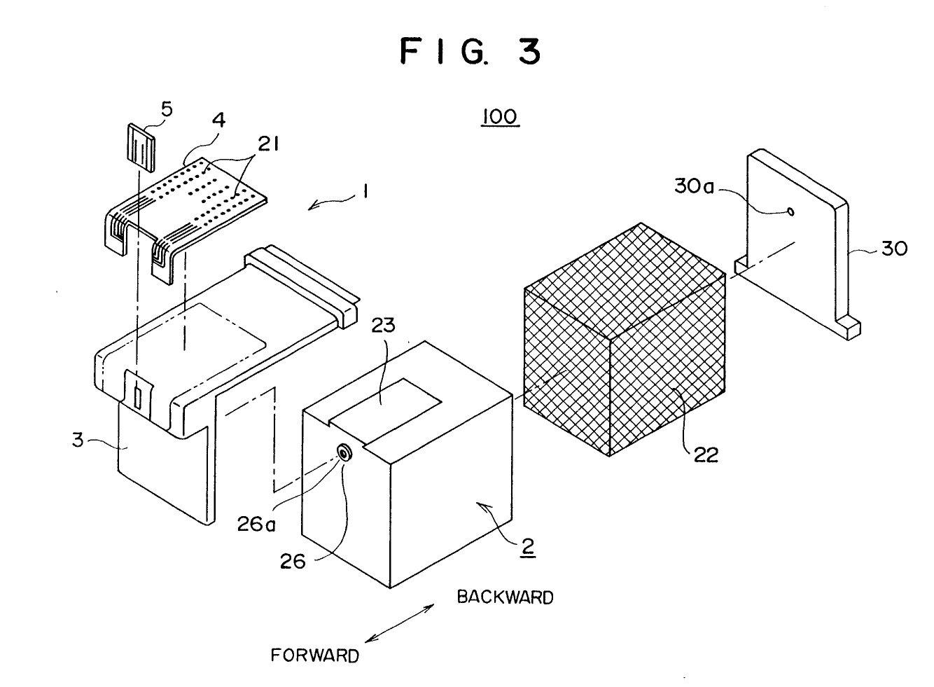

FIG. 1 shows a recording head 100 according to a first embodiment of the present invention in a perspective view, while FIG. 2 shows an elevational cross sectional view of the recording head 100 of FIG. l. Further, FIG. 3 is an exploded view of the recording head 100 of FIG. 1.

Referring to FIG. 1, the recording head 100 is generally formed of a recording head unit 1 and an ink reservoir unit 2, wherein the recording head unit 1 includes a base part 3 that carries thereon a flexible printed circuit board (FPCB) 4 and a head chip 5.

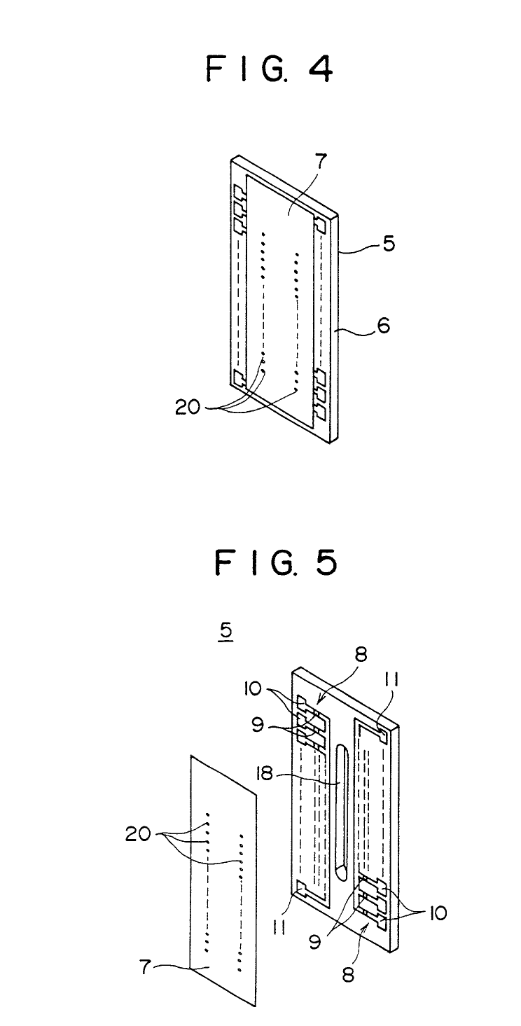

FIGS. 4 and 5 show the head chip 5. Referring to FIGS. 4 and 5, the head chip 5 is generally formed of a substrate 6 and an orifice plate 7. The substrate 6 carries thereon a number of energization parts 8 formed by well known photolithographic processes, wherein, as shown in FIG. 5, the energization part 8 includes a number of resistance patterns 9 acting as a heater, and each resistance pattern 9 is connected to a control electrode 10 for receiving a driving signal and a common electrode 11 connected to the ground.

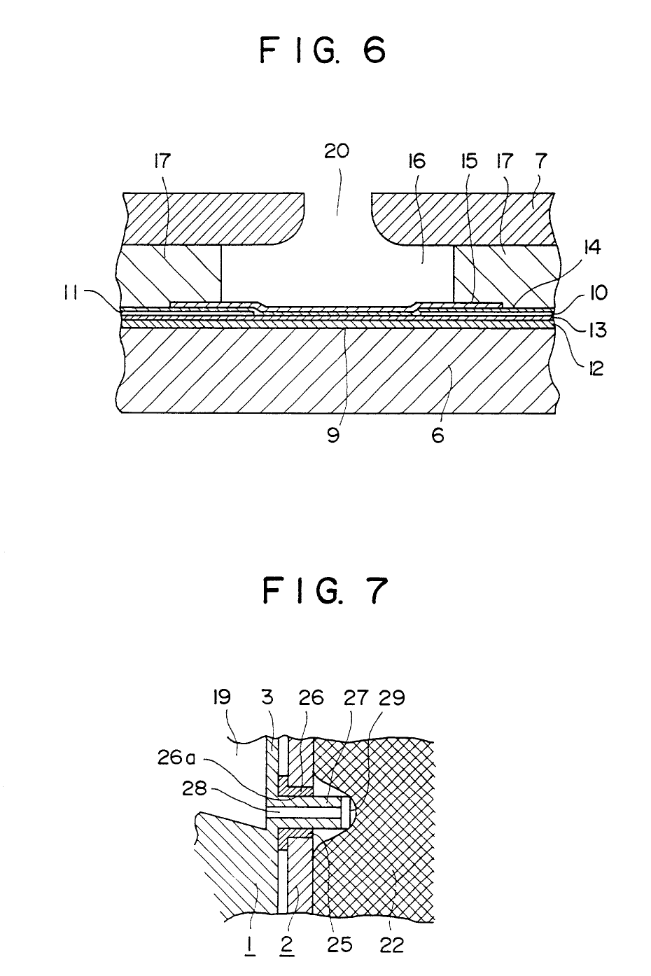

FIG. 6 shows the cross sectional view of the head chip 5, wherein it will be noted that the substrate 6, typically formed of silicon, is covered with a silicon oxide film 12 having a thickness of 1-2 μm, and the silicon oxide film 12 carries thereon a resistance layer 13 of HfB₂ with a thickness of about 3000 Å. Typically, the layer 13 is formed by a sputtering process. The resistance layer 13 is patterned according to the desired shape of a resistance heater 9 by a known photolithographic process, and a layer of Al or Al alloy is deposited on the resistance heater 9 with a thickness of about 1 μm by a sputtering process. The Al layer thus deposited-is patterned subsequently by a photolithographic process to form the electrodes 10 and 11. Further, the resistance heater 9 and the electrodes 10 and 11 thus formed are covered by a protective silicon oxide film 14 deposited by a sputtering process with a thickness of about 1 μm, and another protective film 15 of Ta is deposited on the silicon oxide layer 14 in correspondence to where the resistance heater 9 is formed.

In the foregoing structure of FIG. 6, it should be noted that the silicon oxide film 12 is provided for dissipating heat generated by the resistance heater 9 to the substrate 6 efficiently, while the silicon oxide film 14 is provided to protect the resistance heater 9 or the electrodes 10 and 11 from the corrosion by the ink. On the other hand, the Ta film 15 protects the resistance heater 9 from mechanical shock that is caused in response to the formation of cavitation in the ink. It should be noted that such a shock is caused when the bubbles, formed on the resistance heater 9 as a result of the heating, collapse.

On the substrate 6 thus formed, there is provided an ink barrier structure 17, which defines a passage 16 of ink for guiding the ink to the resistance heater 9, with a thickness of 20-50 μm. Typically, a dry film photoresist is used for the material of the ink barrier structure 17, and the passage 16 is formed with a desired shape as a result of photolithographic patterning process. Further, the substrate 6 is formed with an opening 18 for introducing the ink into the passage 16 as indicated in FIG. 5, wherein the opening 18 penetrates through the substrate 6 from the lower major surface to the upper major surface. Such an opening 18 may be formed by a laser beam cutting or machining process.

FIG. 6 further shows the construction of the orifice plate 7 in the cross sectional view.

Referring to FIG. 6, the orifice plate 7 is provided on the ink barrier structure 17 and may be made of a nickel plate formed by an electro-forming process with a thickness of 50-150 μm, wherein the orifice place 7 thus formed is subsequently subjected to a gold plating process. The orifice plate 7 is provided with a number of nozzles 20 facing the resistance heater 9, wherein each nozzle 20 may have a diameter of 30-50 μm depending upon the specification of the inkjet recording apparatus. As indicated in FIGS. 4 and 5, the nozzle 20 is arranged on the orifice plate 7 in two rows in correspondence to two rows of the resistance heaters 9 .

When assembling the head chip 5, the orifice plate 7 is urged firmly upon the ink barrier structure 17 while applying heat to the structure 17. Thereby, the sticky dry film photoresist of the ink barrier structure 17 holds the orifice plate 7 firmly thereon.

The head chip 5 thus formed as shown in FIG. 4 is then mounted upon the base part 3 as indicated in FIGS. 1-3, and the FPCB 4 is attached upon the base part 3 in electrical connection to the head chip 5 as shown in FIG. l by a wire bonding process. It should be noted that the FPCB 4 carries thereon a number of contact pads 21 for electrical connection to the external apparatus for receiving image signals.

Next, the ink reservoir unit 2 will be described with reference to FIGS. 2 and 3.

Referring to the drawings, the ink reservoir unit 2 forms a case that accommodates therein a deformable porous material 22 infiltrated with ink such as a sponge. The ink reservoir unit 2 is formed so as to be mounted detachably upon the base part 3 and hence to the recording head unit 1 to form the unitary recording head 100, wherein the base part 3 is provided with an ink chamber 19 immediately behind the substrate 6 of the head chip 5 in communication with the opening 18 in the substrate 6. Further, the ink reservoir unit 2 is mounted upon the base part 3 of the recording head unit 1 such that the reservoir 2 is located immediately behind the ink chamber 19.

The base part 3 is formed with a rigid tubular member 27 as an integral part of the base part 3 such that the tubular member 27 projects in the outward direction as indicated in FIG. 7, wherein the tubular member 27 is formed with a passage 28 of ink in communication with the ink chamber 19 for receiving the ink from the ink reservoir unit 2. The ink reservoir unit 2 in turn is provided with a corresponding orifice for accepting the tubular member 27 when the reservoir unit 2 is mounted upon the recording head unit 1, and an elastic seal ring 26 is provided on the orifice 25. The seal ring 26 has a through hole 26a therein, and the tubular member 27 is inserted into the reservoir 2 through the inner hole 26a of the ring 26 as indicated in FIG. 7 when the ink reservoir unit 2 is mounted upon the recording head unit 1. The elastic seal ring 26 thereby provides an effective seal between the recording head unit 1 and the reservoir 2 for preventing the leak of the ink flowing from the ink reservoir unit 2 to the recording head unit 1.

In the state of FIG. 7, the ink held in the reservoir 2 is supplied to the ink chamber 19 of the recording head unit 1 via the passage 28 in the tubular member 27. In order to achieve a reliable sealing action, the diameter of the inner hole 26a of the ring 26 is formed smaller than the outer diameter of the tubular member 27 by about 10-20%. Further, there is provided a filter 29 which is made from stainless steel mesh for eliminating particles or dusts from entering into the ink chamber 19 of the base part 3 with the flow of the ink.

In order to mount the ink reservoir unit 2 properly upon the base part 3 of the recording head unit 1 to form the recording head 100, the ink reservoir unit 2 is provided with a guide part 23 that projects upward on the top surface of the unit 2 as indicated in the exploded view of FIG. 3. In FIG. 3, it will be further noted that the base part 3 has a front plate and a top plate for fitting the front and top surfaces of the reservoir 2 respectively, and a depression 24 is provided on the lower surface of the base part 3 in correspondence to the projection 23 as a corresponding guide part as indicated in FIG. 2. The guide part 23 forms a guide rail extending from the front surface toward the rear surface on the top surface of the ink reservoir unit 2, and a corresponding guide groove forming the guide part 24 extends in the forward direction from the rear edge of the top plate of the base part 3.

When assembling the ink reservoir unit 2 and the recording head unit 1 together, the ink reservoir unit 2 is attached to the base part 3 such that the front edge of the guide part 23 is accepted by the rear edge of the guide part 24. Under this state, the ink reservoir unit 2 is pushed forward with respect to the base part 3 until the tubular member 27 is fully inserted into the reservoir 2 via the inner hole 26a of the elastic ring 26. It should be noted that the ink reservoir unit 2 thus mounted upon the base part 3 of the recording head unit 1 is detachable therefrom by simply pulling it out in the backward direction. Thus, the user of the inkjet printer can replace the ink reservoir unit 2 by simply removing an old ink reservoir unit from the base part 3 and replacing with a new one. It should be noted that the tubular member 27 has a sufficient rigidity that allows insertion into the ink reservoir unit 2 against the resistance exerted by the elastic ring 26.

In the state that the ink reservoir unit 2 is supplied from a vendor, the orifice 25 is sealed by applying a suitable seal means (not shown in FIG. 7) on the elastic ring 26. This seal is broken when the reservoir 2 is mounted upon the base part 3. Because of the rigidity of the tubular member 27, the breaking of the seal is achieved without problem.

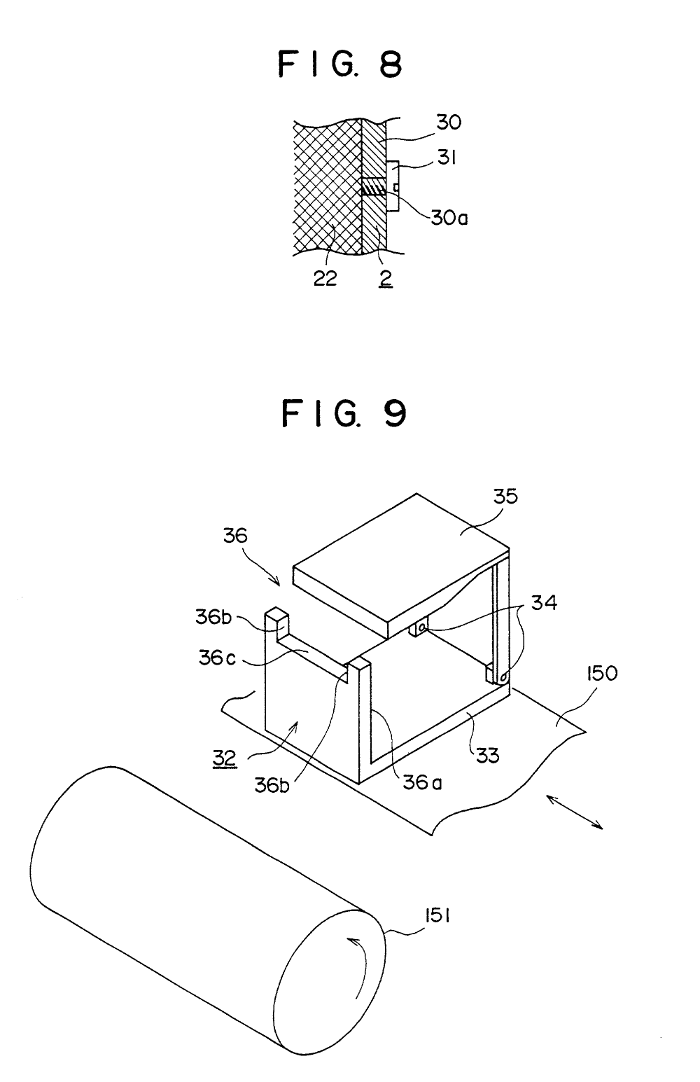

As indicated in FIGS. 2 and 3 or in FIG. 7, the ink reservoir unit 2 accommodates therein a flexible porous material such as a sponge 22 infiltrated with ink, and a rear cover lid 30 closes the rear opening of the ink reservoir unit 2. The cover lid 30 is provided with a minute vent 30a for communicating the interior of the reservoir unit 2 with the surrounding atmosphere for compensating for the drop of pressure that occurs with the consumption of the ink in the ink reservoir unit 2, wherein the vent 30a is plugged with a screw member 31 or other suitable seal means as indicated in FIG. 8 in the state that the unit 2 is supplied from the vendor. When using the unit 2 in an inkjet printer, the user removes the screw member 31.

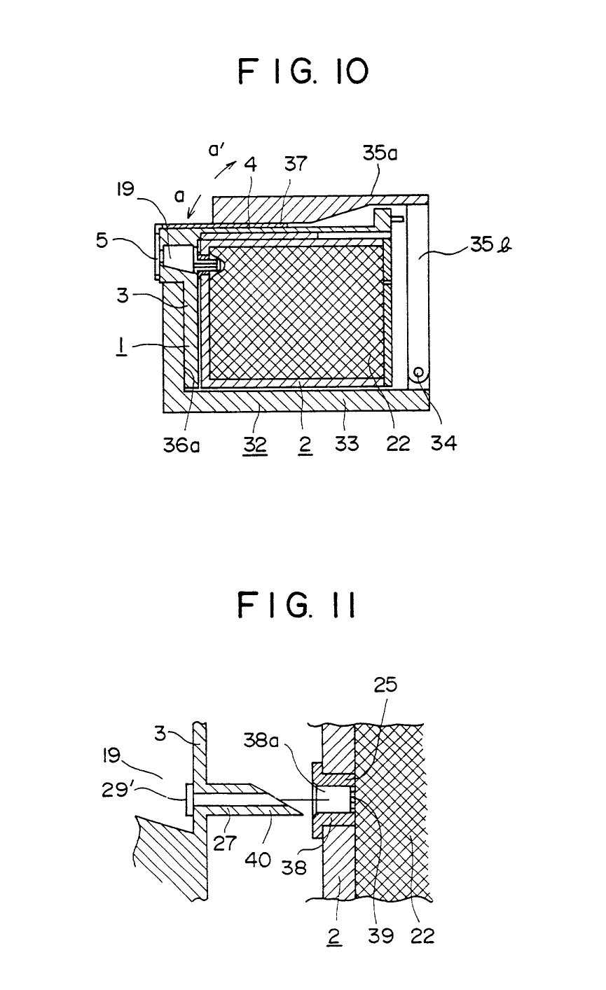

Next, a carriage 32 for carrying the recording head 100 thus formed in an inkjet recording apparatus will be described with reference to FIGS. 9 and 10.

Referring to FIG. 9, the carriage 32 is provided in an inkjet image recording apparatus schematically illustrated by a reference numeral 150, wherein the carriage 32 is held on the recording apparatus 150 in a manner movable in the horizontal scanning direction as indicated by an arrow. As usual in the inkjet printers, there is provided a platen roller 151 for holding a recording sheet thereon, and the recording head 100 carried on the carriage 32 records an image on the recording sheet on the platen roller 151 in the form of dot pattern formed by the inkjet as the head 100 is moved back and forth in the horizontal scanning direction.

The carriage 32 includes an L-shaped base section 33 and an L-shaped cover member 35 held rotatably upon the lower base section 33 at a hinge 34. The L-shaped base section 33 has a front member 36a on which a cutout 36 is formed for holding the base part 3 of the recording head unit 1, wherein the cutout 36 includes two mutually opposing side edges 36b and a bottom edge 36c both formed on the foregoing front member 36a. In the state of FIG. 9, the front surface 3a of the ink reservoir unit 2 (see FIG. 1) contacts with the front member 36a of the L-shaped base section 33.

The cutout 36 holds therein the front projecting part of the base part 3 that carries thereon the head chip 5 and the ink chamber 19 as indicated in FIG. 10. In correspondence to the construction of FIG. 10, it will be noted that the cutout 36 has a shape corresponding to the shape of the projecting part of the base part 3 such that the bottom surface 3c of the projecting part (FIG. 1) is supported by the bottom edge 36c and both lateral sides 3b (FIG. 1) of the projecting part is supported laterally by the side edges 36b.

The L-shaped cover member 35 includes an upper part 35a and a rear part 35b connected with each other and carries thereon contacts 37 at the lower surface of an upper part 35a such that each of the contacts 37 establishes an electrical connection with a corresponding contact pad 21 formed on the recording head unit 1. In order to assure a reliable electrical connection, the cover member 35 is urged in the direction of an arrow a as indicated in FIG. 10 by a spring not illustrated.

When replacing the ink reservoir unit 2, the user rotates the member 35 about the hinge 34 in the direction represented by another arrow a′ against the urging force of the spring and takes out the recording head 100 from the carriage 32. After this, the ink reservoir unit 2 is pulled out in the backward direction with respect to the recording head unit 1 along the guide members 23 and 24 as already described. Next, a new ink reservoir unit 2 is prepared ready for mounting upon the recording head unit 1 by removing the plug or seal of the orifice 25 and further removing the screw or seal 31. The new ink reservoir 2 thus prepared is mounted upon the recording head unit 1 by engaging the guide members 23 and 24 with each other and pushing the unit 2 in the forward direction with respect to the recording head unit 1 along the guide members 23 and 24, until the tubular member 27 is fully inserted into the orifice 25 via the elastic ring 26.

The recording head 100 thus assembled is then returned upon the carriage 32 by rotating the cover member 35 in the direction a′. After fitting the projecting part of the base member 3 in the corresponding positioning cutout 36, the cover member 35 is released and the member 35 rotates in the direction a as a result of the resilient force exerted by the spring. When the cover member 35 is fully rotated, the electric connection is established between the contact pads 21 and the contacts 37.

In the recording head 100 of the present invention, the expensive recording head unit 1 is kept using while only the ink reservoir unit 2 is discarded when the ink is used up. As a result, the running cost of the image recording apparatus is reduced significantly. Further, such a construction of the inkjet printer is suitable for saving valuable resources. Further, it will be noted that the present invention eliminates the need for the complex and tedious work of the user to connect the ink reservoir and the recording head part by one or more tubes. The connection between the ink reservoir unit 2 and the recording head unit 1 is established automatically by simply mounting the ink reservoir unit 2 upon the recording head unit 1. Thereby, it should be noted that the leak of ink at the interconnection part is prevented by the use of the elastic ring 26 that experiences elastic deformation when the tubular member 27 of the recording head unit 1 is inserted into the ink reservoir unit 2.

Further, by providing the filter 29 on the tubular member 27 in correspondence to the tip end part thereof, one can eliminate the penetration of dusts or particles from the ink reservoir unit 2 into the ink chamber 19 and hence into the head chip 5, and the problem of the ink passage 16 or the nozzle 20 of the head chip 5 being interrupted by the dusts is eliminated. The vent 30a on the rear lid 30 guarantees the pressure equilibrium between the interior of the reservoir unit 2 and the surrounding atmosphere, and the supply of the ink from the reservoir unit 2 to the liquid chamber 19 of the recording head unit 1 is maintained even when the amount of ink in the reservoir unit 2 is reduced. As the interior of the ink reservoir unit 2 is sealed by the plug or seal member closing the orifice 25 as well as by the screw 31 or seal member closing the vent 30a in the state when the ink reservoir unit 2 is shipped by a vendor, the evaporation of the ink in the ink reservoir unit 2 during transportation or storage is effectively eliminated.

Another major advantage of the present invention is that the recording head 100 is carried by the carriage 32 with a precise positional alignment thereto as a result of the positioning achieved at the cutout 36 that acts as a positioning means. As the carriage 32 is mounted upon the recording apparatus 150 as schematically indicated in FIG. 9, the precision of the image recording remains substantially unchanged even when the ink reservoir unit 2 is replaced, as the position of the recording head 100 with respect to the recording apparatus 150 is determined by the engagement of the recording head unit 1 with the carriage 32 at the front part of the base part 3 on which the head chip 5 is carried. Further, as the electrical contact of the recording head 100 is achieved on the recording head unit 1 of which position is exactly determined with respect to the carriage 32, a reliable, failure-free electrical connection can be achieved with respect to the recording head 100. Further, the-use of the porous material 22 in the ink reservoir unit 2 eliminates the problem of cavitation in the ink even when the recording head 100 is shaken violently. Thereby, the problem of the bubbles formed in the ink reservoir unit 2 blocking the ink passage 16 is effectively eliminated, and a reliable recoding of images is achieved on a recording sheet.

Next, a second embodiment of the present invention will be described with reference to FIG. 11. In FIG. 11, those parts constructed identically to the parts described previously are designated by the same reference numerals and the description thereof will be omitted.

Referring to FIG. 11, an elastic ring 38 having an inner hole 38a is used in place of the elastic ring 36, wherein the elastic ring 38 has a membrane 39 for sealing the orifice 25. In correspondence to the elastic ring 38 thus configured, the tubular member 27 is formed to have a sharpened tip end 40 such that the sharp tip end 40 breaks the membrane 39 when the reservoir 2 is mounted upon the recording head unit 1 as indicated in FIG. 12. In correspondence to the sharpened shape of the tip end 40 of the tubular member 27, the recording head of the present embodiment carries a filter 29′ in place of the filter 29 in the interior of the liquid chamber 19 in correspondence to the root part of the tubular member 27. According to the construction of the present embodiment, one can eliminate the use of separate plug or seal member for sealing the hole 38a and hence the orifice 25. Further, such a membrane 39 is easily broken by the sharp tip end 40 of the tubular member 27. The construction of the present invention is particularly beneficial to the user of the inkjet printer, as the user can carry out the replacement of the ink reservoir unit 2 without having the stain of ink on the finger.

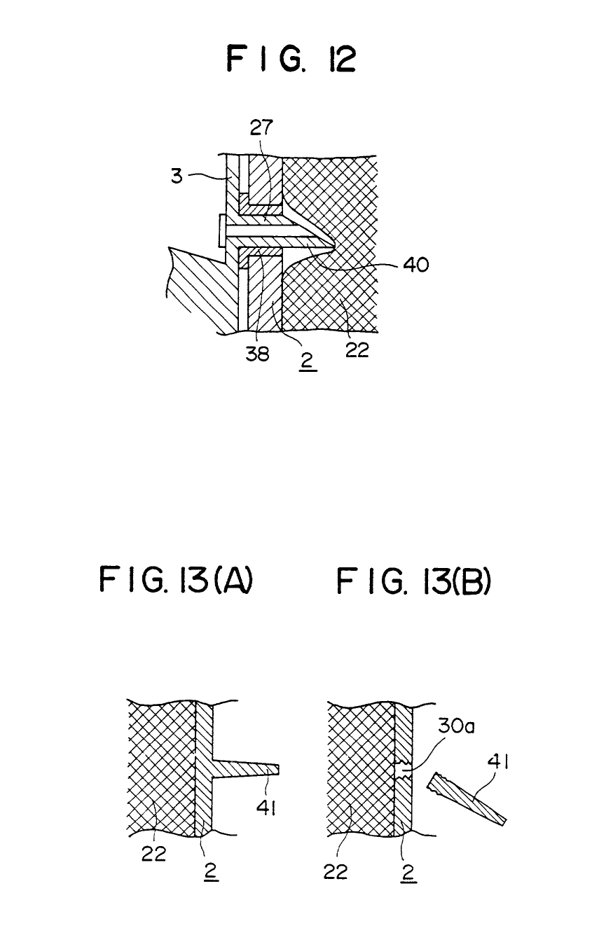

FIGS. 13(A) and 13(B) show a third embodiment of the present invention. In the drawings, those parts configured identically to the parts described previously with reference to preceding drawings are designated by the corresponding reference numerals and the description thereof will be omitted.

In the present embodiment, the ink reservoir unit 2 is formed of a plastic and an elongate, needlelike projection 41 is provided on a part thereof as indicated in FIG. 13(A) in correspondence to where the vent 30a is to be formed. When mounting the ink reservoir unit 2, the projection 41 is broken to form the vent 30a on the wall of the reservoir 2. It should be noted that the vent 30a may be provided on a suitable part of the ink reservoir unit 2. Thus, the part of the ink reservoir unit 2 on which the projection 41 is to be formed is not limited to the rear cover lid 30. In such a construction, too, one can effectively avoid the evaporation of ink in the ink reservoir unit 2 during the transportation or storage.

It should be noted that the present invention is not limited to the recording head of thermal inkjet printers as described heretofore with reference to the embodiments, but is also useful in other types of inkjet printers such as the Gould type printers described in the U.S. Pat. No. 3,683,212, of the stem type printers disclosed in the U.S. Pat. No. 3,746,120, and the Silonics type printers that employs piezoelement for energizing the ink as disclosed in the U.S. Pat. No. 3,946,398.

Because the recording head unit used in the inkjet printers of these various types of non-thermal inkjet printers are generally more expensive as compared with the head used in the thermal inkjet printers, one may have a more distinct effect of cost reduction when the recording head of the present invention is used in combination with these non-thermal inkjet printers as compared with the case of the thermal inkjet printers.

Further, the thermal inkjet printer to which the present invention is applicable is by no means limited to the type described in the embodiments of the present invention wherein the ink is ejected vertically to the plane of the substrate of the head chip. For example, the recording head of the present invention is applicable also to the inkjet printers of the edge-shooter type that eject the ink droplet generally parallel to the surface of the heating element.

Further, the present invention is not limited to the embodiments described heretofore, but various variations and modifications may be made without departing from the scope of the invention.

What is claimed is:

1. A recording head of an inkjet recording apparatus for recording an image on an object, comprising:
a recording head unit supplied with ink for recording an image on a recording object by forming a jet of the ink, said recording head unit comprising: a nozzle for ejecting said jet; a passage of ink provided in communication with said ink nozzle for supplying said ink to said nozzle; an energization part provided on said passage for applying energy to said ink in said passage to form said jet; and an ink inlet formed in communication with said passage for receiving said ink, said inlet including therein filter means which is made from stainless steel mesh for eliminating particles from said ink supplied to said inlet; and
an ink reservoir unit for holding therein said ink, said ink reservoir supplying said ink held therein to said inlet of said recording head part, said ink reservoir accommodating therein a material infiltrated with said ink;
said recording head unit carrying thereon first connection means as a part of said recording head unit, for connecting said recording head unit to said ink reservoir unit;
said ink reservoir unit carrying thereon second connection means corresponding to said first connection means as a part of said ink reservoir unit, for connecting said ink reservoir unit to said recording head unit;
said first and second connection means being so formed that said first and second connection means establish, when said ink reservoir unit is mounted upon said recording head unit, a detachable engagement with each other in a manner, such that said ink in said reservoir unit flows to said passage in said recording head unit.

2. A recording head as claimed in claim 1, wherein said recording head further includes a carriage member adapted to be mounted upon an image recording apparatus for carrying said recording head unit and said reservoir unit together in the state that said recording head unit and said reservoir unit are connected with each other, said carriage member having a positioning part for determining the position of said nozzle of said recording head unit with respect to said carriage member.

3. A recording head as claimed in claim 2, wherein said carriage member includes a base part for carrying said recording head unit and said ink reservoir unit and a cover part mounted upon said base part in a manner rotatable with respect thereto, said base part carrying a positioning part such that said positioning part forms a mechanical engagement with a front part of said recording head unit on which said nozzle is formed, said cover part urging said recording head unit resiliently upon said base part such that said front part of said recording head unit establishes said mechanical engagement with said positioning part.

4. A recording head as claimed in claim 3, wherein said cover part carries thereon an interconnection pattern for carrying electric signals, and wherein said recording head unit carries thereon an interconnection pattern corresponding to said interconnection pattern on said cover part, said recording head unit thereby establishing an electrical contact with said interconnection pattern when said recording head unit and said ink reservoir unit are mounted upon said carriage member.

5. A recording head as claimed in claim 1, wherein said recording head unit has a first guide part for guiding said ink reservoir unit with respect to said recording head unit for mounting and dismounting said ink reservoir unit on and from said recording head unit, said ink reservoir unit having a corresponding second guide part for engagement with said first guide part.

6. A recording head as claimed in claim 1, wherein said second connection means of said ink reservoir unit comprises an opening and an elastic seal part sealing said opening, said first connection means of said recording head unit being provided so as to establish a communication between said recording head unit and said ink reservoir unit via said elastic seal part when said ink reservoir unit is mounted upon said recording head unit.

7. A recording head as claimed in claim 1, wherein said first connection means of said recording head unit comprises a substantially rigid tubular member for insertion into said ink reservoir unit such that said tubular member breaks said seal membrane when said ink reservoir unit is mounted upon said recording head part, said tubular member having a passage of ink therein in communication with said passage of ink in said recording head unit.

8. A recording head as claimed in claim 7, wherein said tubular member has a sharp pointed part that breaks said seal membrane when said ink reservoir unit is mounted upon said recording head unit.

9. A recording head as claimed in claim 1, wherein said ink reservoir unit further has a vent for communicating an interior and an exterior of said ink. reservoir unit, said vent being closed by a removable seal member.

10. A recording head as claimed in claim 9, wherein said removable seal member comprises a screw threaded into a wall of said ink reservoir unit.

11. A recording head as claimed in claim 9, wherein said removable seal member comprises a substantially rigid projection formed unitrarily to a wall of said ink reservoir unit in correspondence to said vent for closing said vent, said projection being so shaped that said vent is formed upon breaking of said projection.
